(19) United States
(12) Patent Application Publication
(10) Pub. No.: US 2026/0054716 A1
(43) Pub. Date: Feb. 26, 2026

(54) VEHICULAR COLLISION AVOIDANCE USING COMBINED LATERAL AND LONGITUDINAL TRAJECTORIES

(71) Applicant: GM GLOBAL TECHNOLOGY OPERATIONS LLC, Detroit, MI (US)

(72) Inventors: Daniel Y. Rubin, Holon (IL); Avshalom Suissa, Ganei Tikva (IL); Oded Yechiel, Rishon LeZion (IL)

(73) Assignee: GM GLOBAL TECHNOLOGY OPERATIONS LLC, Detroit, MI (US)

(21) Appl. No.: 18/810,755

(22) Filed: Aug. 21, 2024

(51) Int. Cl. B60W 30/09; B60W 10/18; B60W 10/20; B60W 40/068; B60W 40/072

(52) U.S. Cl. CPC B60W 30/09; B60W 10/18; B60W 10/20; B60W 40/068; B60W 40/072; B60W 2520/10; B60W 2530/10; B60W 2552/40; B60W 2710/18; B60W 2710/20

(57) ABSTRACT

A system and method for generating combined lateral and longitudinal trajectories for vehicular collision avoidance. The system and method include determining, offline from a vehicle, a set of optimized trajectories for the vehicle in avoiding a potential collision with an obstacle, where the set of optimized trajectories include a combined set of lateral and longitudinal vehicular motions that are stored in a database within the vehicle. Within the vehicle, a state estimation of the vehicle is determined and includes fetching, based on the state estimation, within the vehicle, a trajectory from the set of optimized trajectories. Based on the selected trajectory, one or more actuators within the vehicle are engaged, where the one or more actuators generate a simultaneous lateral and longitudinal motion of the vehicle in avoidance of the potential collision with the obstacle.

### INTRODUCTION

Vehicles are a staple of everyday life. Special use cameras, microcontrollers, laser technologies, and sensors may be used in many different applications in a vehicle. Cameras, microcontrollers, and sensors may be utilized in enhancing automated structures that offer state-of-the-art experience and services to the customers, for example in tasks such as body control, steering control, camera vision, information display, security, autonomous controls, etc. Further, functions utilizing multiple image sensors, may be used in situations to detect and react to objects, such as pedestrians, objects, and other vehicles, which may have a bearing on the operation of a vehicle.

Vehicles may use multiple cameras, which may produce a 360-degree overhead perspective of the vehicle and the area surrounding the vehicle, including possible obstructions and obstacles. Such a perspective may assist the driver in various maneuvers such as parking or navigating around different objects. In addition, cameras may be used to detect objects and initiate evasive maneuvers if appropriate. However, cameras may also detect objects where the vehicle is on an unavoidable collision path. Short of stopping the vehicle there may not exist an alternative solution.

Accordingly, it is desirable to provide collision avoidance with the use of both lateral and longitudinal vehicular control to avoid a predicted potential collision.

### SUMMARY

Disclosed herein are systems and methods for generating combined lateral and longitudinal trajectories for vehicular collision avoidance. A method for generating combined lateral and longitudinal trajectories for vehicular collision avoidance may include determining, offline from a vehicle, a set of optimized trajectories for the vehicle in avoiding a potential collision with an obstacle, wherein the set of optimized trajectories includes a combined set of lateral and longitudinal vehicular motions that are stored in a database within the vehicle. The method may also include determining, within the vehicle, a state estimation of the vehicle and then fetching, based on the state estimation, within the vehicle, a trajectory from the set of optimized trajectories. The method may also include engaging, based on the selected trajectory, one or more actuators within the vehicle, where the one or more actuators generate a simultaneous lateral and longitudinal motion of the vehicle in avoidance of the potential collision with the obstacle.

Another aspect of the disclosure may be a method of determining the state estimation of the vehicle that includes a road friction coefficient, a road geometry, and a mass of the vehicle.

Another aspect of the disclosure may be a method of predicting, based on the state estimation and a scene model, a desired vehicle lateral offset.

Another aspect of the disclosure may be a method fetching the trajectory based on the state estimation and the desired vehicle lateral offset.

Another aspect of the disclosure may be a method where the longitudinal motion of the vehicle includes a braking action.

Another aspect of the disclosure may be a method where the lateral motion of the vehicle includes a steering action.

Another aspect of the disclosure may be a method where the set of optimized trajectories are based on a kinematic model including a vehicle pose, a vehicle velocity, and a set of vehicle grip constraints in a lateral and a longitudinal direction.

Another aspect of the disclosure may be a method where the vehicle grip constraints are less than or equal to a squared value of a road friction coefficient times a gravity coefficient times a mass of the vehicle.

Another aspect of the disclosure may be a method of determining an index of optimized trajectories that includes a weighted least squares matrix where (w1*(dᵢ−d)\hat{ }2+w2*(muᵢ−mu)\hat{ }2+w3*(vxᵢ−vx)\hat{ }2+w4*(rhoᵢ−rho)\hat{ }2), where (dᵢ−d) includes a difference in a trajectoryᵢ lateral distance from a desired lateral distance, (muᵢ−mu) includes a difference in a trajectoryᵢ road friction from an estimated road friction, (vxᵢ−vx) includes a difference in a trajectoryᵢ velocity from a measured velocity, and (rhoᵢ-rho) includes a difference in a trajectoryᵢ road curvature from an estimated road curvature.

Another aspect of the disclosure may be a method of retrieving a trajectoryᵢ from the database within the vehicle based on the result of (w1*(dᵢ−d)\hat{ }2+w2*(muᵢ−mu)\hat{ }2+w3*(vxᵢ−vx)\hat{ }2+w4*(rhoᵢ−rho)\hat{ }2).

Another aspect of the disclosure may include a system for generating combined lateral and longitudinal trajectories for vehicular collision avoidance that includes a vehicle configured with an integrated database system, where the database system includes a database of offline optimized trajectories for vehicular collision avoidance. The system may also include a state estimation system, within the vehicle, to generate, based on vehicular sensors, a state estimation of the vehicle. The system may also include a decision making system, based on a scene model and the state estimation, to generate a desired vehicular lateral offset. The system may also include a fetching system, based on the state estimation and desired vehicular lateral offset, to retrieve an offline optimized trajectory from the database of offline optimized trajectories. The system may also include vehicular trajectory tracking controls, based on a retrieved offline optimized trajectory, to issue commands to one or more vehicle actuators, where the one or more vehicle actuators may be used to generate a lateral motion and a longitudinal motion of the vehicle in avoidance of a potential collision with an obstacle.

Another aspect of the system may include where the state estimation system is used to utilize a road friction coefficient, a road geometry, and a mass of the vehicle.

Another aspect of the system may include where the longitudinal motion of the vehicle includes a braking action.

Another aspect of the system may include where the lateral motion of the vehicle includes a steering action, a differential braking, and adaptive drive torque distribution.

Another aspect of the system may include where the offline optimized trajectories are based on a kinematic model include a vehicle pose, a vehicle velocity, and a set of vehicle grip constraints in a lateral and a longitudinal direction.

Another aspect of the system may include where the vehicle grip constraints are less than or equal to a squared value of a road friction coefficient times a gravity coefficient times a mass of the vehicle.

Another aspect of the system may include where an index of offline optimized trajectories that includes a weighted least squares matrix where (w1*(dᵢ−d)\hat{ }2+w2*(muᵢ−mu)\hat{ }2+w3*(vxᵢ−vx)\hat{ }2+w4*(rhoᵢ−rho)\hat{ }2), where (dᵢ−d) includes a difference in a trajectoryᵢ lateral distance from a desired lateral distance, (muᵢ−mu) includes a difference in a trajectoryᵢ road friction from an estimated road friction, (vxᵢ−vx) includes a difference in a trajectoryᵢ velocity from a measured velocity, and (rhoᵢ−rho) includes a difference in a trajectoryᵢ road curvature from an estimated road curvature.

Another aspect of the system may include where the fetching system is further used to retrieve a trajectoryᵢ from the database of offline optimized trajectories within the vehicle based on the result of (w1*(dᵢ−d)\hat{ }2+w2*(muᵢ−mu)\hat{ }2+w3*(vxᵢ−vx)\hat{ }2+w4*(rhoᵢ−rho)\hat{ }2).

Another aspect of the system may include where the vehicular trajectory controls are further used to issue commands to the one or more vehicle actuators to simultaneously generate the lateral motion and the longitudinal motion.

Another aspect of the disclosure may include a method for generating combined lateral and longitudinal trajectories for vehicular collision avoidance that include determining, offline from a vehicle, a set of optimized trajectories for the vehicle in avoiding a potential collision with an obstacle, where the set of optimized trajectories include a combined set of lateral and longitudinal vehicular motions that are stored in a database within the vehicle, and where the set of optimized trajectories are based on a kinematic model including a vehicle pose, a vehicle velocity, and a set of vehicle grip constraints in a lateral and a longitudinal direction. The method may also include determining, within the vehicle, a state estimation of the vehicle, where the determining the state estimation of the vehicle includes a road friction coefficient, a road geometry, and a mass of the vehicle. The method may also include predicting, based on the state estimation and a scene model, a desired vehicle lateral offset while also fetching, based on the state estimation and the desired vehicle lateral offset, within the vehicle, a trajectory from the set of optimized trajectories. The method may also include engaging, based on the selected trajectory, one or more actuators within the vehicle, where the one or more actuators generate a simultaneous lateral motion including a steering action and a longitudinal motion of a braking action of the vehicle in avoidance of the potential collision with the obstacle.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an illustration of a variety of possible vehicle sensors, in accordance with the disclosure.

FIG. 2 is a flowchart of a method of combined lateral and longitudinal trajectories for vehicular collision avoidance, in accordance with the disclosure.

FIG. 3 is an illustration of multiple lateral and longitudinal trajectories for vehicular collision avoidance, in accordance with the disclosure.

FIG. 4 depicts a flowchart of a method of combined lateral and longitudinal trajectories for vehicular collision avoidance using a neural network, in accordance with the disclosure.

FIG. 5 depicts a method of combined lateral and longitudinal trajectories for vehicular collision avoidance, in accordance with the disclosure.

The appended drawings are not necessarily to scale and may present a somewhat simplified representation of various features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiments in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

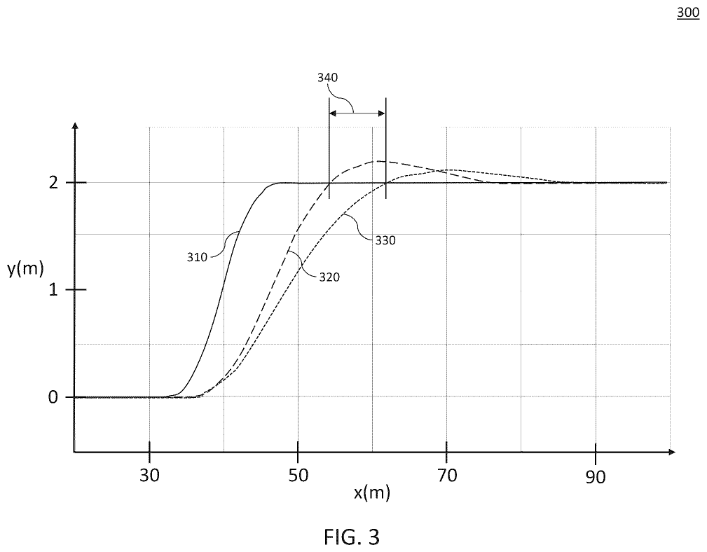

Referring to the drawings, the left most digit of a reference number identifies the drawing in which the reference number first appears (e.g., a reference number ‘310’ indicates that the element so numbered is first labeled or first appears in FIG. 3). Additionally, elements which have the same reference number, followed by a different letter of the alphabet or other distinctive marking (e.g., an apostrophe), indicate elements which may be the same in structure, operation, or form but may be identified as being in different locations in space or recurring at different points in time (e.g., reference numbers “110a” and “110b” may indicate two different input devices which may be functionally the same, but may be located at different points in a simulation arena).

Vehicles have become computationally advanced and equipped with multiple microcontrollers, cameras, sensors, processors, and control systems, including for example, autonomous vehicle and advanced driver assistance systems (AV/ADAS) such as adaptive cruise control, automated parking, automatic brake hold, automatic braking, evasive steering assist, lane keeping assist, adaptive headlights, backup assist, blind spot detection, cross traffic alert, local hazard alert, and automatic braking that may depend on information obtained from cameras and sensors on a vehicle. Such information may be combined and utilized to assist or automate a collision avoidance maneuver, for example the use of braking and steering commands.

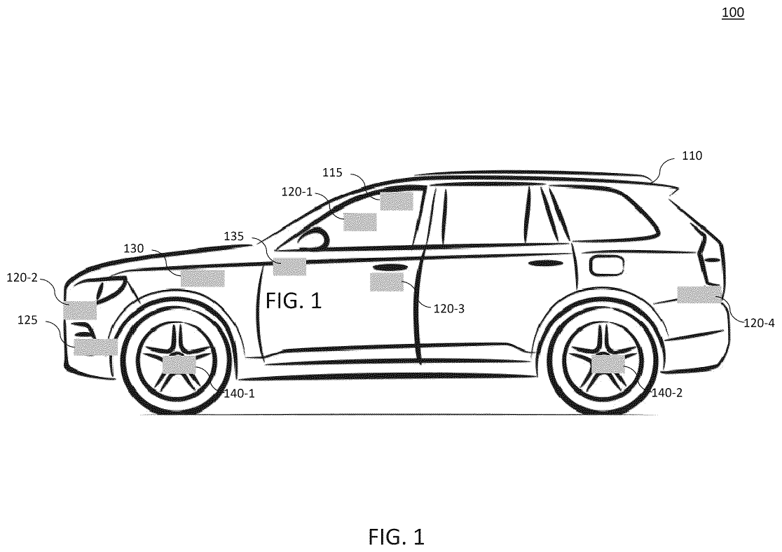

FIG. 1 is an illustration of a vehicle with integrated sensors 100, according to an embodiment of the present disclosure. Such sensors may assist in the use of automated functions, such as autonomous driving and, as discussed, the ability to initiate and assist or automate a collision avoidance maneuver. For example, vehicle 110 may include a Light Detection And Ranging (Lidar) sensor 115, an inward or outward camera sensor 120 (as shown by camera sensor 120-1-120-4), an ultrasonic sensor 125, an inertial measurement unit (IMU) sensor130, a steering angle sensor 135, and wheel speed sensors 140-1 and 140-2, to name a few. Camera sensor 120 may also include multiple camera sensors placed around and throughout the vehicle, for example, camera sensor 120-1 mounted by the windshield facing forward, camera sensor 120-2 located at the front of the vehicle, facing forward, camera sensor 120-3 located at the left-side of the vehicle (with another side mounted camera sensor located at the right-side of the vehicle (not shown)), and camera-sensor 120-4 located at the rear of the vehicle. Other additional cameras and sensors at other locations may also be possible to provide additional views and/or operations.

Images from camera sensors 120, especially from front facing cameras such as camera sensor 120-1 and camera sensor 120-2, may detect an obstacle. Processors within the vehicle may determine that there is a potential collision between the vehicle and a detected obstacle. The obstacle may be another vehicle, a pedestrian, or other moving or stationary object. Processors within the vehicle may be used to determine a state estimation of the vehicle such as a velocity of the vehicle, a velocity of the obstacle, a coefficient of friction with the road, a geometry of the road, and a mass of the vehicle, to name a few. The state estimation may be used in conjunction with a scene model, e.g., a determination of the current vehicle situation, for example the distance between the vehicle and the obstacle, relative angles between the vehicle and the obstacle, and other environmental factors and based on the scene model and state estimation generate a prediction of a possible collision and generate a decision based on these factors. Such decisions may include determining one or more desirable trajectories for the vehicle to obtain a desired lateral distance between the vehicle and the obstacle. Processors within the vehicle may then determine a desired or optimal trajectory for the current situation. Such an optimal trajectory may include generating one or more control commands for the vehicle, for example, a braking control and a steering control.

However, the computation of a set of optimized trajectories and then selecting a desired optimized trajectory may be computationally complex. In addition, such calculations, based on the state and scene estimations, may be computationally unachievable in a desired timeframe to efficiently react to a possible collision.

Accordingly, as discussed in this disclosure, a set of offline optimizations of trajectories may be calculated and stored within the vehicle. Thus, a database of optimized trajectories may be stored within the vehicle. The database may include optimized trajectories for a multiple of scenes and various vehicle states where such calculations could be determined offline by a cloud application or server and then loaded into the vehicle, or even calculated by the vehicle in an offline mode. Thus, in the event of a predicted collision between the vehicle and an obstacle, the vehicle may rely on fetching, from a database of offline optimized trajectories, a desired trajectory based on the conditions and situation of the vehicle.

Further, the database of optimized trajectories may also include trajectories for an avoidance maneuver that consists of a combination of lateral and longitudinal motions. For example, generating simultaneous, near simultaneous, or synchronized control commands for both a braking action and a steering action. While including a braking action may appear counter-intuitive, as user initiated braking actions may typically be used to defeat or cancel an automated action, here the braking action has been used to increase automated collision avoidance efficiency as will be shown in FIG. 3.

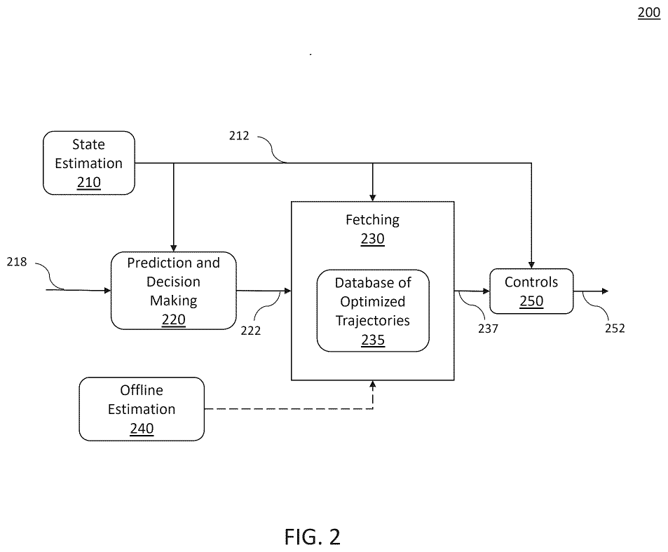

FIG. 2 is a flowchart of a method of combined lateral and longitudinal trajectories 200 for vehicular collision avoidance, according to an embodiment of the present disclosure. State estimation system 210 may determine a state of the vehicle at a particular moment in time. For example, state estimation system 210 may determine some of the vehicle's physical characteristics including a vehicle's position and velocity. The position, as will be used in FIG. 3, may be envisioned as a position within coordinates (x, y) in an x and y plane, where x represents a longitudinal direction and y represents a latitudinal direction. Similarly, the vehicle's velocity may also be shown as (vₓ, v_{y}) with velocities in the x and y planes. The state estimation system 210 may also determine such state characteristics as tire-road friction or a road friction coefficient that represents the amount of adhesion between the road and the vehicle through the contact of the tires. The road friction coefficient may also be affected by weather conditions, temperature, road composition, etc. In addition, a mass of the vehicle and a road geometry may also affect the value of the road friction coefficient. Road geometry may also include the road characteristics such as banking angle, amount of curve, road surface composition, etc.

State estimation system 210 may determine these state variables 212 and pass them on to a prediction and decision making system 220, fetching system 230, and controls 250. Prediction and decision making system 220 may receive as inputs the output from state estimation system 210 and scene model 218. Scene model 218 may include current vehicle situation data, such as data gathered from vehicle sensors. Such data may include image data from cameras such as camera sensor 120, vehicle data such as velocity, and sensor data such as information from Lidar or other radar type sensors. In addition, a vehicle inertial measurement unit may provide additional information including acceleration/deceleration in both lateral and longitudinal directions. Scene model 218 may also include information regarding a detected obstacle, such as an obstacle detected by a camera sensor 120, including information regarding its size, distance from the vehicle, position, and other relevant information.

The prediction and decision making system 220 may, based on scene model 218 and state variables 212, predict a desired lateral offset distance (d) 222. A desired lateral offset distance (d) 222 may be based on a minimum distance between the vehicle and an obstacle and also include a margin or threshold distance amount. In an embodiment, the lateral offset may be the smallest possible clearance distance to be engaged as later as possible, thereby allowing the driver the maximum amount of time to react.

Fetching system 230 may receive inputs including state variables 212 and a desired lateral offset distance (d) 222. Fetching system 230 may also include a database of optimized trajectories 235 that have been obtained from the offline estimation system 240.

Offline estimation system 240 may generate a set of optimized trajectories based on a kinematic model. For example, for a given initial velocity (vₓ₀), a desired lateral distance (d), and a road friction coefficient (μ), the goal is to find trajectories that minimizes the escape distance (X), e.g., gives the maximum distance from the obstacle for the desired lateral distance.

Optimization may be based on a kinematic model with:
states x, y, vₓ, v_{y}, ρ,
inputs: Fₓ, F_{y},
grip constraints Fₓ²+F_{y}²≤(μmg)²
   where:
x and y represent a vehicle's position in an x-y plane;
vₓ and v_{y} represent the vehicle's velocity in the x-y plane;
Fₓ and F_{y} represent the vehicle's force between the vehicle and the roadway that includes:
   a braking friction in the longitudinal direction (Fₓ) and
   a steering friction in the latitudinal direction (F_{y})
μ represents a road friction coefficient;
m represents a mass of the vehicle;
g represents a gravitational force; and
ρ represents the upcoming road curvature.

Offline estimation system 240 may then solve for the optimized trajectories offline thus allowing for complex models and constraints to increase accuracy as needed. Such offline calculations may use a dynamic model given the non-linear responses in the vehicle's tires, suspension, and other components and with additional constraints including steering rate and braking force. Multiple trajectories may be calculated based on the various conditions encountered such as discussed above with vehicle state estimation and scene conditions.

Once the various optimized trajectories have been computed and stored in the database of optimized trajectories 235, the fetching system 230 may identify the optimal of the trajectories. Thus, first the database of optimized trajectories 235 contains a set of i trajectories may be created as follows:
1. Create a list A of parameter sets {d, vₓ, u, ρ};
2. For each set {d, vₓ, μ, ρ}ᵢ∈A (set i in the list A); and
3. Solve optimal trajectory and store in database of optimized trajectories 235 at index i.

Once the database of optimized trajectories 235 containing i entries is created, then the vehicle while online may fetch, using fetching system 230 an optimal trajectory from the database of optimized trajectories 235 as follows:
1. Given a vehicle's current measured velocity (vₓ), estimated road friction (μ), road curvature (ρ), and desired lateral distance (d) find the best fitting set {d, vₓ, μ, ρ}ᵢ ∈A where:

$${arg}_{i}^{min} [ {d}_{i} - d , {v}_{xi} - {v}_{x} , {μ}_{i} - μ , {ρ}_{i} - ρ ] {W [ {d}_{i} - d , {v}_{xi} - {v}_{x} , {μ}_{i} - μ , {ρ}_{i} - ρ ]}^{T}$$

Where W is a weight matrix
2. Retrieve trajectory i from the database of optimized trajectories 235 and send to controllers.

In an embodiment the weight matrix may be represented as follows:

$$w 1 * {( {d}_{i} - d )}^{2} + w 2 * {( {μ}_{i} - μ )}^{2} + w 3 * {( {v}_{xi} - {v}_{x} )}^{2} + w 4 * {( {ρ}_{xi} - {ρ}_{x} )}^{2}$$

Once the desired trajectory 237 has been fetched by fetching system 230 then the fetching system 230 may send the desired trajectory 237 to controls 250 that in turn may generate the appropriate control commands 252 within the vehicle that may be passed to the appropriate vehicle actuators. The control commands 252 sent to engage various actuators may include steering commands, braking commands, and other appropriate commands as would be known by one of ordinary skill in the art.

FIG. 3 illustrates vehicle trajectories 300, according to an embodiment of the present disclosure. Vehicle trajectories 300 are shown with three possible trajectories including a target trajectory 310, a combined lateral and longitudinal control trajectory 320, and a lateral control trajectory 330. The target trajectory 310 may represent the desired trajectory 237 as discussed in FIG. 2 that was fetched from the database of optimized trajectories 235. In response to the target trajectory 310 the vehicle may generate both steering command and braking commands, for example from controls 250, that may be sent to the corresponding steering and braking actuators to affect the desired outcome. However, given the vehicle's state and scenes as discussed in FIG. 2, the best obtainable trajectory may be represented as the trajectory 320 that is based on the use of steering and braking commands. As a comparison, trajectory 330 represents the use of just lateral control, e.g., steering commands, absent longitudinal controls such as braking. The net result is to decrease the minimal distance required to avoid a collision by the distance 340. Such a decrease illustrates a significant improvement in the performance of a collision avoidance both in terms of decreasing the minimal distance required to avoid a collision but also in providing the driver additional time to react to the situation. As previously mentioned, the use of braking typically would be used to cancel an automated vehicle response, but in this case, it is being used to improve the performance of an automated vehicle maneuver.

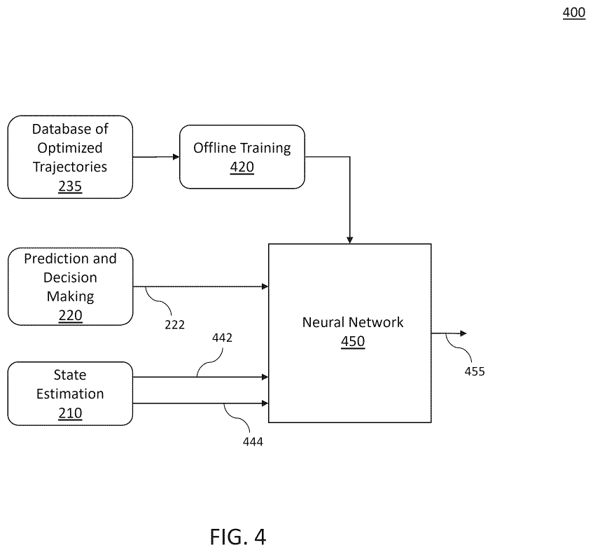

FIG. 4 is a flowchart 400 of a method of combined lateral and longitudinal trajectories for vehicular collision avoidance using a function, such as a neural network, linear regression fitting, etc., according to an embodiment of the present disclosure. Flowchart 400 may include the state estimation system 210 as discussed in FIG. 2 that includes determining a vehicle's velocity vₓ 422 and road friction coefficient μ 444, which may then be passed to neural network 450. Flowchart 400 may also include the prediction and decision making system 220 as discussed in FIG. 2 that includes determining a desired lateral offset distance (d) 222, which may then also be passed to neural network 450.

Flowchart 400 also includes the database of optimized trajectories 235 discussed in FIG. 2 that may be used as an input to an offline training module 420. Offline training module 420 may then use the database of optimized trajectories 235 as training data for the neural network 450. Neural network 450 may then be used in place of the fetching system 230 in FIG. 2 to retrieve a desired trajectory 455, which may then be sent to vehicle controls to the appropriate vehicle actuators to generate actions, for example a braking action and a steering action as previously discussed.

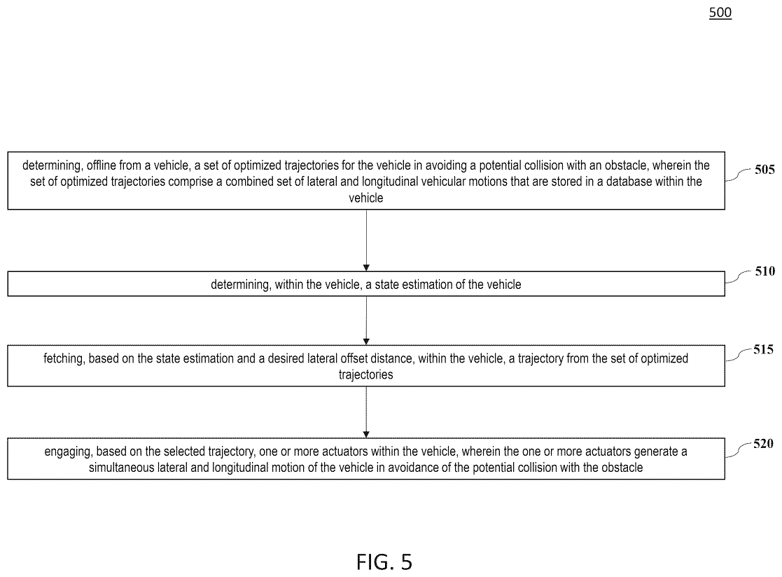

FIG. 5 illustrates a detail flowchart of method 500 for generating combined lateral and longitudinal trajectories for vehicular collision avoidance, according to an embodiment of the present disclosure. FIG. 5 may begin with step 505 that includes determining, offline from a vehicle, a set of optimized trajectories for the vehicle in avoiding a potential collision with an obstacle, wherein the set of optimized trajectories include a combined set of lateral and longitudinal vehicular motions that are stored in a database within the vehicle. As discussed in FIG. 1, processors and sensors within a vehicle may be used to scan and detect obstacles in the environment surrounding a vehicle. Obstacles may be stationery, inanimate objects or moving objects such as another vehicle, or even a pedestrian. The sensors within a vehicle may be used to process and identify such objects and determine if there exists the possibility of an imminent potential collision.

To avoid a possible collision with an obstacle the vehicle may initiate a variety of evasive maneuvers. However, rather than attempting to compute an optimal trajectory to avoid the obstacle on the fly, a set of predetermined optimized trajectories may be stored within a database as discussed in FIG. 2. An offline estimation system 240 may generate a set of optimize trajectories based on a kinematic model, where for example, a given initial velocity (vₓ₀), a desired lateral distance (d), a road friction coefficient (μ), and the road curvature (ρ), may be used to determine a trajectory that minimizes the escape distance (X), e.g., gives the maximum distance from the obstacle for the desired lateral distance from the obstacle. The desired lateral distance (d) may be defined to be a minimal acceptable lateral distance between the obstacle and the vehicle.

The determination of an optimized trajectory may be based on the state of the vehicle, for example its position, velocity, and a friction coefficient with the roadway. It may also be dependent on grip constraints between the vehicle and the roadway, for example a braking friction constraint in the longitudinal direction of travel of the vehicle and a steering friction in the latitudinal direction of the vehicle. In addition, factors such as the mass of the vehicle and a road friction coefficient between the tires of the vehicle and the roadway, and gravity may also be considered.

The database of optimized trajectories within the vehicle may be based on a wide variety of conditions and situations the vehicle may encounter. The database may then be considered to contain a list of optimal trajectories stored in the database at an index location, where each index location is associated with a set of input parameters. The input parameters may include such data sets as a desired lateral offset distance, an initial velocity, and a road friction coefficient.

At step 510 a determining may be made, within the vehicle, a state estimation of the vehicle. The state estimation of the vehicle may include factors such as a velocity of the vehicle, a velocity of the obstacle, a coefficient of friction with the road, a geometry of the road, and a mass of the vehicle. The state estimation of the vehicle is directed to the physical aspects of the vehicle and may include additional descriptive variables to describe a vehicle's characteristics.

At step 515 the method may include fetching, based on the state estimation and a desired lateral offset distance, within the vehicle, a trajectory from the set of optimized trajectories. As discussed, the database of optimized trajectories contains a list of optimal trajectories stored and indexed, where each index location is associated with a set of input parameters. The input parameters may include state estimation parameters, such as an initial velocity of the vehicle and a friction coefficient between the tires of the vehicle and the roadway. Also, as further discussed, the fetching from the set of optimized trajectories may also be based on the desired lateral offset distance. The desired lateral offset distance (d) may be defined to be a minimal acceptable lateral distance between the obstacle and the vehicle.

At step 520 the method may continue with an engaging, based on the selected trajectory, one or more actuators within the vehicle, wherein the one or more actuators generate a simultaneous lateral and longitudinal motion of the vehicle in avoidance of the potential collision with the obstacle. As discussed in FIG. 2, once the desired trajectory 237 has been fetched by fetching system 230 then the fetching system 230 may send the desired trajectory 237 to controls 250 that in turn may generate the appropriate control commands 252 within the vehicle that may be passed to the appropriate vehicle actuators. The control commands 252 sent to engage various actuators may include at least steering and braking commands to affect the lateral and longitudinal trajectories of the vehicle.

Method 500 may then end.

The description and abstract sections may set forth one or more embodiments of the present disclosure as contemplated by the inventor(s), and thus, are not intended to limit the present disclosure and the appended claims.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof may be appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by one or more of the above-described exemplary embodiments.

Exemplary embodiments of the present disclosure have been presented. The disclosure is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the disclosure.

What is claimed is:

1. A method for generating combined lateral and longitudinal trajectories for vehicular collision avoidance comprising:
determining, offline from a vehicle, a set of optimized trajectories for the vehicle in avoiding a potential collision with an obstacle, wherein the set of optimized trajectories comprise a combined set of lateral and longitudinal vehicular motions that are stored in a database within the vehicle;
determining, within the vehicle, a state estimation of the vehicle;
fetching, based on the state estimation, within the vehicle, a trajectory from the set of optimized trajectories; and
engaging, based on the fetched trajectory, one or more actuators within the vehicle, wherein the one or more actuators generate a simultaneous lateral and longitudinal motion of the vehicle in avoidance of the potential collision with the obstacle.

2. The method of claim 1, wherein the determining the state estimation of the vehicle comprises a road friction coefficient, a road geometry, and a mass of the vehicle.

3. The method of claim 1, further comprising predicting, based on the state estimation and a scene model, a desired vehicle lateral offset.

4. The method of claim 3, further comprising fetching the trajectory based on the state estimation and the desired vehicle lateral offset.

5. The method of claim 1, wherein the longitudinal motion of the vehicle comprises a braking action.

6. The method of claim 1, wherein the lateral motion of the vehicle comprises a steering action.

7. The method of claim 1, wherein the set of optimized trajectories are based on a kinematic or dynamic model comprising a vehicle pose, a vehicle velocity, and a set of vehicle grip constraints in a lateral and a longitudinal direction.

8. The method of claim 7, wherein the vehicle grip constraints is less than or equal to a squared value of a road friction coefficient times a gravity coefficient times a mass of the vehicle.

9. The method of claim 1, further comprising determining an index of optimized trajectories that comprises a weighted least squares matrix where (w1*(dᵢ−d)\hat{ }2+w2*(muᵢ−mu)\hat{ }2+w3*(vxᵢ−vx)\hat{ }2+w4*(rhoᵢ−rho)\hat{ }2), where (dᵢ−d) comprises a difference in a trajectoryᵢ lateral distance from a desired lateral distance, (muᵢ−mu) comprises a difference in a trajectoryᵢ road friction from an estimated road friction, (vxᵢ−vx) comprises a difference in a trajectoryᵢ velocity from a measured velocity, and (rhoᵢ−rho) comprises a difference in a trajectoryᵢ road curvature from an estimated road curvature.

10. The method of claim 9, further comprising retrieving a trajectoryᵢ from the database within the vehicle based on the result of (w1*(dᵢ−d)\hat{ }2+w2*(muᵢ−mu)\hat{ }2+w3*(vxᵢ−vx)\hat{ }2+w4*(rhoᵢ−rho)\hat{ }2).

11. A system for generating combined lateral and longitudinal trajectories for vehicular collision avoidance comprising:
a vehicle configured with an integrated database system, wherein the database system comprises a database of offline optimized trajectories for vehicular collision avoidance;
a state estimation system, within the vehicle, configured to generate, based on vehicular sensors, a state estimation of the vehicle;
a decision making system, based on a scene model and the state estimation, configured to generate a desired vehicular lateral offset;
a fetching system, based on the state estimation and desired vehicular lateral offset, configured to retrieve an offline optimized trajectory from the database of offline optimized trajectories; and
vehicular trajectory tracking controls, based on a retrieved offline optimized trajectory, configured to issue commands to one or more vehicle actuators, wherein the one or more vehicle actuators are configured to generate a lateral motion and a longitudinal motion of the vehicle in avoidance of a potential collision with an obstacle.

12. The system of claim 11, wherein the state estimation system is configured to utilize a road friction coefficient, a road geometry, and a mass of the vehicle.

13. The system of claim 11, wherein the longitudinal motion of the vehicle comprises a braking action.

14. The system of claim 11, wherein the lateral motion of the vehicle comprises a steering action, a differential braking, and adaptive drive torque distribution.

15. The system of claim 11, wherein the offline optimized trajectories are based on a kinematic model comprising a vehicle pose, a vehicle velocity, and a set of vehicle grip constraints in a lateral and a longitudinal direction.

16. The system of claim 15, wherein the vehicle grip constraints is less than or equal to a squared value of a road friction coefficient times a gravity coefficient times a mass of the vehicle.

17. The system of claim 11, wherein an index of offline optimized trajectories that comprises a weighted least squares matrix where (w1*(dᵢ−d)\hat{ }2+w2*(muᵢ−mu)\hat{ }2+w3*(vxᵢ−vx)\hat{ }2+w4*(rhoᵢ−rho), where (dᵢ−d) comprises a difference in a trajectoryᵢ lateral distance from a desired lateral distance, (muᵢ−mu) comprises a difference in a trajectoryᵢ road friction from an estimated road friction, (vxᵢ−vx) comprises a difference in a trajectoryᵢ velocity from a measured velocity, and (rhoᵢ−rho) comprises a difference in a trajectoryᵢ road curvature from an estimated road curvature.

18. The system of claim 17, wherein the fetching system is further configured to retrieve a trajectoryᵢ from the database of offline optimized trajectories within the vehicle based on a result of (w1*(dᵢ−d)\hat{ }2+w2*(muᵢ−mu)\hat{ }2+w3*(vxᵢ−vx)\hat{ }2+w4*(rhoᵢ−rho)).

19. The system of claim 11, wherein the vehicular trajectory controls are further configured to issue commands to the one or more vehicle actuators to simultaneously generate the lateral motion and the longitudinal motion.

20. A method for generating combined lateral and longitudinal trajectories for vehicular collision avoidance comprising:
determining, offline from a vehicle, a set of optimized trajectories for the vehicle in avoiding a potential collision with an obstacle, wherein the set of optimized trajectories comprise a combined set of lateral and longitudinal vehicular motions that are stored in a database within the vehicle, and wherein the set of optimized trajectories are based on a kinematic model comprising a vehicle pose, a vehicle velocity, and a set of vehicle grip constraints in a lateral and a longitudinal direction;
determining, within the vehicle, a state estimation of the vehicle, wherein the determining the state estimation of the vehicle comprises a road friction coefficient, a road geometry, and a mass of the vehicle;
predicting, based on the state estimation and a scene model, a desired vehicle lateral offset;
fetching, based on the state estimation and the desired vehicle lateral offset, within the vehicle, a trajectory from the set of optimized trajectories; and
engaging, based on the fetched trajectory, one or more actuators within the vehicle, wherein the one or more actuators generate a simultaneous lateral motion comprising a steering action and a longitudinal motion comprising a braking action of the vehicle in avoidance of the potential collision with the obstacle.
